(19) United States
(12) Patent Application Publication
(10) Pub. No.: US 2015/0301242 A1
(43) Pub. Date: Oct. 22, 2015

(54) OPTICAL FILTERS HAVING IMPROVED COLOR PROFILE PATTERNS

(71) Applicant: Mount July, Stanford, CA (US)

(72) Inventors: OLIVIA VAGELOS, Stanford, CA (US); Martin Bush, Oakland, CA (US)

(21) Appl. No.: 14/577,306

(22) Filed: Dec. 19, 2014

Related U.S. Application Data
(60) Provisional application No. 61/919,161, filed on Dec. 20, 2013.

(51) Int. Cl. G02B 5/20

(52) U.S. Cl. CPC G02B 5/201

(57) ABSTRACT

In various embodiments, the invention provides photographic and image capture device lenses having variations in color and tone profiles arranged based on differing geometric relationships to the physical shape of the lens, and further allows for the lenses to be stacked such that the visual effects provided by each lens can be applied simultaneously.

### CROSS REFERENCE TO RELATED APPLICATIONS

This application claims priority to and the benefit of U.S. provisional patent application Ser. No. 61/919,161, entitled “Optical Filters Having Improved Color Profile Patterns” filed on Dec. 20, 2013, the entire contents of which are incorporated herein by reference.

### FIELD OF THE INVENTION

This application is directed to the field of optical filters, and in particular to optical filters having improved color profile patterns.

### BACKGROUND

Photography is an increasingly popular activity and art form amongst both professionals and hobbyists. Many photographers use optical filters to alter the images they capture. An optical filter is a device that selectively transmits certain wavelengths of light, while blocking others. Optical filters can be designed in a variety of shapes (e.g. circle, square, and oblong), and are usually adapted to fit over the lens of a camera.

Use of an optical filter has a number of known effects. In some applications, optical filters are used to enhance the clarity of an image by, for example, modifying its contrast or creating a more balanced exposure. Other optical filters can be used to add, change, or subtract a certain color from a scene. For example, if an image shows the sky as a drab grey, a filter can be used to make it appear as a vibrant blue.

In some optical filters, one section of the filter transmits all light (i.e., is a clear filter), while another section only transmits light of a certain wavelength. In such optical filters, the transition between the sections occurs along a linear path and can be either abrupt or gradual.

Although optical filters are a useful tool for photographers, they have drawbacks as well. Current optical filters offer severely limited options for altering an image. All known optical filters contain at least one of the following limitations: (1) only transitions between clear and a single color; (2) only transitions between colors in a linear pattern; or (3) only transitions between colors in an abrupt, non-graduated fashion. While such filters are well suited for certain specific applications, their limited ability to alter images can stifle a photographer's creativity.

Further, although images can be altered by methods other than using a filter, for example, manipulating camera settings such as aperture size and shutter speed; presently, the only way to alter an image without being restricted by one of the above limitations is through the use of digital image altering techniques. The desire of users to increase their image alteration options can be seen in the recent success of companies that offer such digital techniques such as Instagram and Ribbet. However, digital techniques are not without drawbacks of their own. Such techniques do not use an optical filter at all, but rather digitally manipulate the pixels of an image. Many photographers are averse to the digital approach and prefer to alter images through the manipulation of light using an optical filter. Many believe this technique enhances the skill and creativity involved in photography and creates images of higher quality.

Thus, what is needed is an improved optical filter that allows users to continue altering images through light manipulation, but which also addresses the limitations of current filters by offering more image alteration options, thereby facilitating increased photographer creativity.

### SUMMARY OF THE INVENTION

Aspects of the present invention aim to enhance the photography experience by offering optical filters with improved capabilities over those currently available.

One aspect of the invention relates to an optical filter having a tone and a color profile. The color profile can transition between multiple different colors, for example, from a first color to a second color to a third color. The transition between colors may occur in either an abrupt or a gradual fashion. The color profile may have, for example, a radial or a linear pattern. In an embodiment having a radial pattern, the radial pattern may have a center point different than the geometric center of the optical filter. The center point of the radial pattern may be either inside or outside the geometric boundaries of the optical filter. The optical filter may comprise a variety of optically transparent materials, for example, multi-coated precision glass or high quality plastic.

In an embodiment, the optical filter may be adapted to fit within a housing adapted to connect to an image capturing device. The housing, which may comprise an aluminum material, can connect to the image capturing device using a set of threads. The image capturing device may capture film photographs, digital photographs, or videos, and can have a lens with a diameter of, for example, 52 mm, 58 mm, or 77 mm.

The optical filter may be adapted to be stacked in a parallel plane to at least one other optical filter, and may be adapted to rotate independently of any other optical filter.

### BRIEF DESCRIPTION OF THE FIGURES

In the figures, like reference characters generally refer to the same parts throughout the different views. Also, the figures are not necessarily to scale, emphasis instead is generally being placed upon illustrating the principles of the invention.

FIG. 1 shows an exemplary optical filter having a tone and a color profile associated with it according to an embodiment of the invention.

FIG. 2 shows an exemplary radial color profile pattern according to an embodiment of the invention.

FIG. 3 shows an exemplary radial color profile pattern having a center point different than the geometric center of the optical filter and located inside the geometric boundaries of the optical filter according to an embodiment of the invention.

FIG. 4 shows an exemplary radial color profile pattern having a center point different than the geometric center of the optical filter and located outside the geometric boundaries of the optical filter according to an embodiment of the invention.

FIG. 5 shows an exemplary linear color profile pattern according to an embodiment of the invention.

FIG. 6 shows an exemplary housing and image capturing device that may be used in embodiments of the invention.

FIG. 7 shows an exemplary effect of rotating a single optical filter according to an embodiment of the invention.

FIG. 8 shows an exemplary effect of rotating multiple optical filters stacked in parallel planes to one another according to an embodiment of the invention.

### DETAILED DESCRIPTION

The invention may be better understood by reference to the following detailed description, taken in conjunction with the figures.

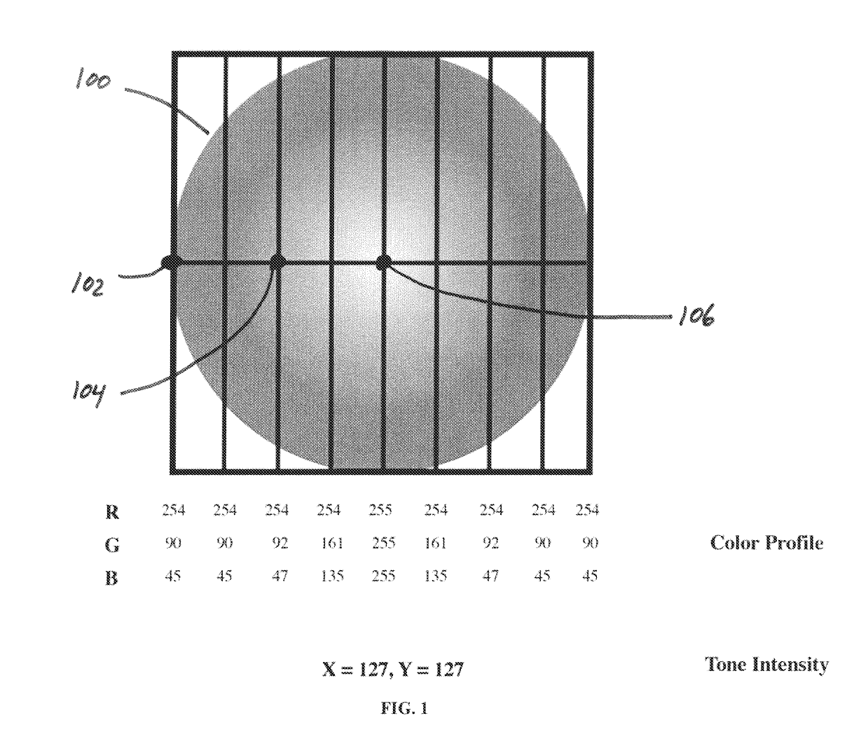

FIG. 1 shows an exemplary optical filter 100 according to an embodiment of the invention. The optical filter may comprise an optically transparent material, for example, multi-coated coated precision glass or high quality plastic, and can be designed in many shapes, for example, circle, square, or oblong. The optical filter 100 may have a tone associated with it that defines the total amount of light it is calibrated to transmit. In the present application, tone is defined by an XY parameter having an X component and a Y component, where either component can be independently varied on a scale from 0 to 255. The extreme ends of the spectrum exist at an XY parameter of X=0, Y=255 (resulting in a “white transparent” image) and X=255, Y=0 (resulting in a “black transparent” image). The tone associated with an optical filter 100 of various embodiments of the invention may be defined by an XY parameter anywhere along this spectrum. For example, in the exemplary optical filter 100 the tone is defined by an XY parameter of X=127, Y=127.

The optical filter 100 may contain a color profile that defines the colors it is calibrated to transmit and those it is calibrated to block. In the present application, the color profile is defined by a collection of RGB parameters each having an R (“red”) component, a G (“green”) component, and a B (“blue”) component, where any component can be independently varied using, for example, a scale from 0 to 255. For example, an optical filter having an RGB parameter of R=255, G=0, and B=0 would only transmit the color red. Through variance of the R, G, and B components, the transmission and/or blockage of a wide range of colors can be controlled. The RGB parameters may differ at different points across the optical filter's surface. An example of this concept can be seen in FIG. 1. At point 102, the filter has an RGB parameter of R=254, G=90, and B=45, at point 104 it has an RGB parameter of R=254, G=92, and B=47, and at point 106 it has an RGB parameter of R=255, G=255, and B=255. Thus, different colors are transmitted at points 102, 104, and 106. The collection of all the RGB parameters across a given optical filter define its color profile.

In some embodiments, the color profile may transition between clear and a single color. In other embodiments, the color profile may transition between multiple colors. As just one of many examples, the color profile may transition from yellow to orange to purple.

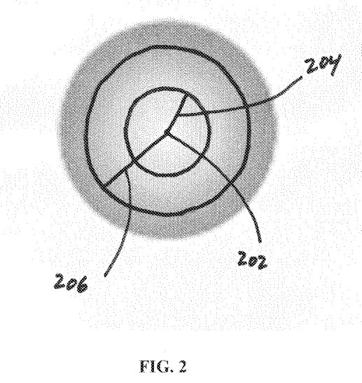

The color profile may transition between colors in a variety of patterns. A non-exclusive list of such patterns includes a radial pattern and a linear pattern. FIG. 2 shows an exemplary radial color profile pattern. In a radial pattern, the color profile may transition between colors at various radial distances from a center point 202. For example, the color profile may have a first color at a first radial distance 204 from the center point, and a second color at a second radial distance 206 from the center point. The transitions between colors in a radial pattern can be either abrupt or gradual.

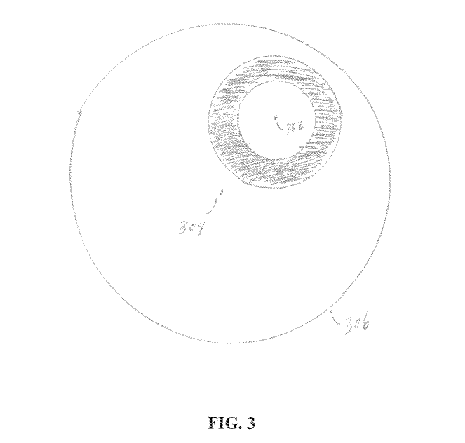

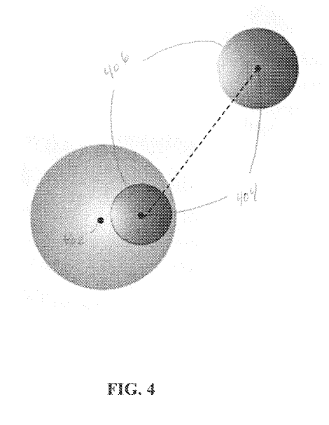

In certain embodiments, a center point of the radial color profile pattern may be different than (e.g., offset from) the geometric center of the optical filter. As shown, for example, in FIG. 3, the center point 302 of the radial color profile pattern may be different than the geometric center 304 of the optical filter, and be located within the geometric boundaries of the optical filter 306. Alternatively, as shown, for example, in FIG. 4, the center point 402 of the radial color profile pattern may be different than the geometric center 404 of the optical filter, and be located outside the geometric boundaries of the optical filter 406.

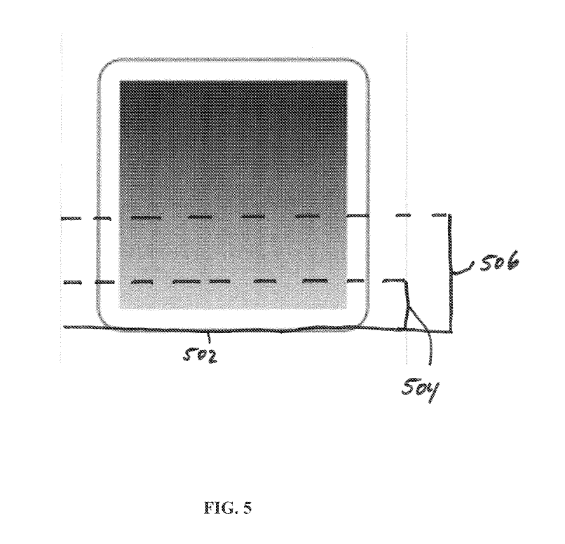

FIG. 5 shows an exemplary linear color profile pattern. In a linear pattern the color profile may transition between colors at various linear distances from an edge 502 of the optical filter. For example, the color profile may have a first color at a first linear distance 504 from the edge, and a second color at a second linear distance 506 from the edge. The transition between colors in a linear pattern can be either abrupt or gradual.

The optical filter as described above can significantly reduce the image altering limitations of current optical filters. As just one example, an optical filter of the invention may allow for transitions between multiple colors in non-linear graduated patterns, a capability current optical filters do not have.

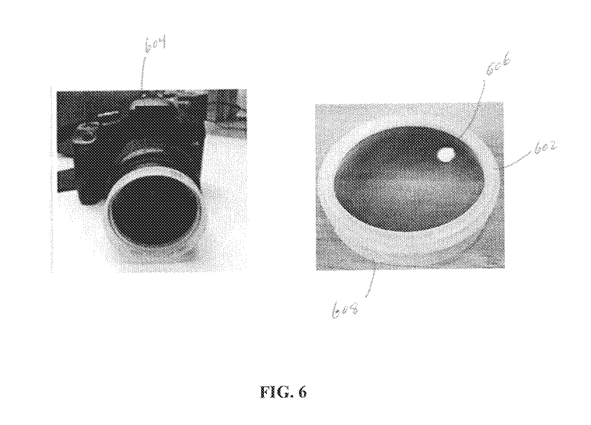

The optical filter can be mounted to an image capturing device in any way either now known or that may be known in the future. In some embodiments, the optical filter may be adapted to fit within a housing 602 that connects to an image capturing device 604 as shown, for example, in FIG. 6. This configuration may allow the optical filter to be oriented such that it intercepts at least some of the light entering a lens of the image capturing device. The housing 602 may be any standard housing known in the art, and may be made from lightweight durable aluminum or any other suitable material. The optical filter may be adapted to fit within the housing 602 using standard techniques, including, for example, being set within an interior groove 606 of the housing. The housing 602 may connect to the image capturing device 604 using standard techniques, including, for example, via a threaded interface 608. The housing 602 can be adapted to fit image capturing devices of a wide range of sizes, including, but not limited to, those having lens diameters of 52 mm, 58 mm, and 77 mm. The image capturing device may be any device that captures film photographs, digital photographs, or video. For example, the image capturing device may include the Canon Rebel and Nikon V-Series cameras.

In certain other embodiments, the optical filters may be attached to or integrated with a housing that attaches to a mobile or portable communication device such as a cellular phone or tablet computer, which often include one or more cameras.

In some embodiments, multiple optical filters may be stacked in parallel planes to one another such that at least some of the light transmitted from an image passes through each optical filter before reaching the lens of an image capturing device. In one embodiment, each of the stacked optical filters may both connected to the same image capturing device. Use of multiple optical filters may alter images even more than a single optical filter because light from an image may be passed through additional tones and color profiles before reaching the image capturing device's lens.

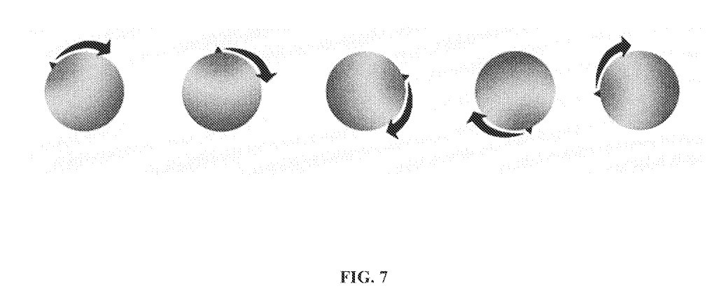

In certain embodiments the optical filters may be adapted to rotate. For example, the optical filters may sit in a groove bearing placed in an interior groove of the housing. Rotation of a single optical filter may alter the same image in different ways by, for example, passing light from the image through different parts of the filter's color profile. FIG. 7 shows an exemplary effect of this process.

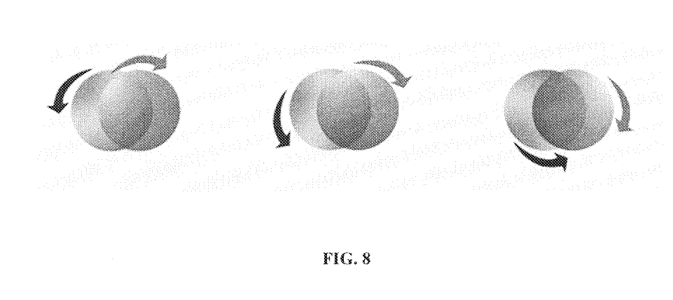

Additionally, in an embodiment where multiple optical filters are stacked in parallel planes to one another, each optical filter may be adapted to rotate independently of any other optical filter. This configuration may alter the same image in different ways by, for example, passing light from the image through multiple filters, as well as different parts of the color profile of each of those filters. In an embodiment having a radial color profile pattern with a center point different than the geometric center of the optical filter, there may be a change in visual effect during rotation as new parts of the patterns are overlaid on one another in different parts of the image frame. FIG. 8 shows an exemplary effect of this process.

1. A light filtering apparatus comprising:
an optical filter having a tone and a color profile, wherein the color profile transitions from a first color to a second color to a third color; and
wherein the optical filter is adapted to be stacked in a parallel plane to at least one other optical filter and is adapted to rotate independently of the at least one other optical filter.

2. The light filtering apparatus of claim 1 wherein the color profile transitions between colors in an abrupt fashion.

3. The light filtering apparatus of claim 1 wherein the color profile transitions between colors in a gradual fashion.

4. The light filtering apparatus of claim 1 wherein the color profile is arranged in a radial pattern.

5. The light filtering apparatus of claim 4 wherein a center point of the radial pattern is different than a geometric center of the optical filter.

6. The light filtering apparatus of claim 4 wherein a center point of the radial pattern has a location of inside the geometric boundaries of the optical filter.

7. The light filtering apparatus of claim 4 wherein a center point of the radial pattern has a location of outside the geometric boundaries of the optical filter.

8. The light filtering apparatus of claim 1 wherein the color profile is arranged in a crescent pattern.

9. The light filtering apparatus of claim 1 wherein the color profile is arranged in a linear pattern.

10. The light filtering apparatus of claim 1 wherein the optical filter comprises multi-coated precision optical glass.

11. The light filtering apparatus of claim 1 wherein the optical filter comprises plastic.

12. The light filtering apparatus of claim 1 wherein the optical filter is adapted to fit within a housing adapted to connect to an image capturing device using a set of threads.

13. The light filtering apparatus of claim 12 wherein the image capturing device captures at least one of film photographs, digital photographs, and video.

14. The light filtering apparatus of claim 12 wherein, a lens of the image capturing device has a diameter of at least one of 52 mm, 58 mm, and 77 mm.
